(19) United States
(12) Patent Application Publication
(10) Pub. No.: US 2021/0312248 A1
(43) Pub. Date: Oct. 7, 2021

(54) SYSTEM AND METHOD FOR SEQUENTIAL PROBABILISTIC OBJECT CLASSIFICATION

(71) Applicant: TECHNION RESEARCH & DEVELOPMENT FOUNDATION LIMITED, Haifa (IL)

(72) Inventors: Vladimir TCHUIEV, Karmiel (IL); Vadim INDELMAN, Haifa (IL)

(21) Appl. No.: 17/266,601

(22) PCT Filed: Aug. 8, 2019
(86) PCT No.: PCT/IL2019/050900

§ 371 Date: Feb. 7, 2021

Related U.S. Application Data
(60) Provisional application No. 62/715,863, filed on Aug. 8, 2018.

(51) Int. Cl. G06K 9/62; G06N 3/08

(52) U.S. Cl. CPC G06K 9/6277; G06K 9/628; G06K 9/00664; G06N 3/08; G06K 9/6228

(57) ABSTRACT

Methods and systems are provided for classifying an object appearing in multiple sequential images. The process includes determining a neural network classifier having multiple object classes for classifying objects in images; determining a likelihood classifier model comprising a likelihood vector of class probability vectors; for each image z, running the image multiple respective times through the neural network classifier, applying dropout each time, to generate a point cloud of class probability vector values {γₜ}; calculating a vector of posterior distributions {λₜ} for each class and for each of the multiple {γₜ}, where calculating each class element of {λₜ} includes calculating a product of the respective element of the class probability vectors and an element of the posterior distribution of a prior image; randomly selecting a subset of {λₜ} to form a new subset of {λₜ}; and repeating the calculation of the subset {λₜ} for each of the images, to determine a cloud of posterior probability vectors approximating a distribution over posterior class probabilities, given all the multiple sequential images.

### FIELD OF THE INVENTION

The present invention relates to image processing for machine vision.

### BACKGROUND

Classification and object recognition is a fundamental problem in robotics and computer vision, a problem that affects numerous problem domains and applications, including semantic mapping, object-level SLAM, active perception and autonomous driving. Reliable and robust classification in uncertain and ambiguous scenarios is challenging, as object classification is often viewpoint dependent, influenced by environmental visibility conditions such as lighting, clutter, image resolution and occlusions, and limited by a classifier's training set. In these challenging scenarios, classifier output can be sporadic and highly unreliable. Moreover, approaches that rely on most likely class observations can easily break, as these observations are treated equally regardless if the most likely class has high probability or not, potentially giving large significance to ambiguous observations. Indeed, modern (deep learning based) classifiers provide much richer information that is being discarded by resorting to only most likely observations. Current convolutional neural network (CNN) classifiers provide not only vector of class probabilities (i.e. probability for each class), but, recently, also output an uncertainty measure, quantifying how (un)certain each of these probabilities is. Even though CNN-based classification has achieved some good results in the last few years, as with any data driven method, actual performance heavily depends on the training set. In particular, if the classified object is represented poorly in the training set, the classification result will be unreliable and vary greatly with slightly different NN classifier weights. This variation is referred to as model uncertainty. High model uncertainty tends to arise from input that is far from the NN classifier's training set, which could be caused by an object not being in the training set or by occlusions. In addition, classification, where each frame is treated separately, is influenced by environmental conditions such as lighting and occlusions. Consequently, it can provide unstable classification results.

Various methods have been proposed to compute model uncertainty from a single image, the disclosures of which are hereby incorporated by reference, such as: Yarin Gal and Zoubin Ghahramani, “Dropout as a Bayesian approximation: Representing model uncertainty in deep learning,” Intl. Conf. on Machine Learning (ICML), 2016 (hereinbelow, “Gal and Ghahramani”); and Pavel Myshkov and Simon Julier, “Posterior distribution analysis for Bayesian inference in neural networks,” Advances in Neural Information Processing Systems (NIPS), 2016. To address this problem, various Bayesian sequential classification algorithms that maintain a posterior class distribution were developed. These include the following, the disclosures of which are hereby incorporated by reference: W T Teacy, et al., “Observation modeling for vision-based target search by unmanned aerial vehicles,” Intl. Conf. on Autonomous Agents and Multiagent Systems (AAMAS), pp. 1607-1614, 2015; Javier Velez, et al., “Modeling observation correlations for active exploration and robust object detection,” J. of Artificial Intelligence Research, 2012; T. Patten, et al., “Viewpoint evaluation for online 3-d active object classification,” IEEE Robotics and Automation Letters (RA-L), 1(1):73-81, January 2016.

Methods have also been developed for computing model uncertainty for deep learning applications. A normalized entropy of class probability may be used as a measure of classification uncertainty, as described by Grimmett et al., “Introspective classification for robot perception,” Intl. J. of Robotics Research, 35(7):743-762, 2016, whose disclosures are incorporated herein by reference. However, none of these approaches address model uncertainty. Crucially, while posterior class distribution fuses all classifier outputs thus far, it does not provide any indication regarding how reliable the posterior classification is. In Bayesian inference over continuous random variables (e.g. SLAM problem), this would correspond to getting the maximum a posteriori solution without providing the uncertainty covariances. Clearly, this is highly undesired, in particular in the context of safe autonomous decision making (e.g. in robotics, or for self-driving cars), where a key question is when should a decision be made given available data thus far. (See, for example, Indelman, et al., “Incremental distributed inference from arbitrary poses and unknown data association: Using collaborating robots to establish a common reference.” IEEE Control Systems Magazine (CSM), Special Issue on Distributed Control and Estimation for Robotic Vehicle Networks, 36(2):41-74, 2016, the disclosures of which are hereby incorporated by reference.)

On the other hand, existing approaches that account for model uncertainty do not consider sequential classification. As a consequence, none of the existing approaches reason about the posterior uncertainty, given images previously acquired. To draw conclusions about uncertainty in posterior classification, it would be useful to maintain a distribution over posterior class probabilities while accounting for model uncertainty.

### SUMMARY OF THE INVENTION

Embodiments of the present invention provide methods and systems for classifying an object appearing in multiple sequential images, by a process including: determining a neural network (NN) classifier having multiple object classes for classifying objects in images; determining a likelihood classifier model comprising a likelihood vector of class probability vectors; for each image z, running the image multiple respective times through the NN classifier, applying dropout each time, to generate a point cloud of class probability vector values {γₜ}; calculating a vector of posterior distributions {λₜ} for each class and for each of the multiple {γₜ}, where calculating each class element of {λₜ} includes calculating a product of the respective element of the class probability vectors and an element of the posterior distribution of a prior image; randomly selecting a subset of {λₜ} to form a new subset of {λₜ}; repeating the calculation of the subset {λₜ} for each of the images, to determine a cloud of posterior probability vectors approximating a distribution over posterior class probabilities, given all the multiple sequential images.

### BRIEF DESCRIPTION OF THE DRAWINGS

For a more complete understanding of the invention, reference is made to the following description and accompanying drawings, in which:

FIGS. 1a-g illustrate examples for inference of a posterior class distribution, [symbol] (λₖ|z_{1:k}), from [symbol] (γₖ|zₖ) and [symbol] (λₖ₋₁|z_{1:k}) using a known classifier model, considering three possible classes, according to embodiments of the present invention;

FIGS. 2a-d illustrate a case where posterior uncertainty grows with each additional image viewed, according to embodiments of the present invention;

FIGS. 3a-c illustrate probabilities of a classifier likelihood model for three classes, and FIGS. 3d-f illustrate classification point clouds for three images, according to embodiments of the present invention;

FIGS. 4a-d present results in terms of expectation [symbol] (λₖⁱ) and \sqrt{Var(λzₖⁱ)} for each of three classes, as a function of classifier measurements, according to embodiments of the present invention;

FIGS. 5a-c present the development of {λₖ} point clouds showing the spread of points at different time steps, according to embodiments of the present invention;

FIGS. 6a-d present four of the dataset images, exhibiting occlusions, blur, and different colored filters in a monotone environment, according to embodiments of the present invention;

FIGS. 7a-f present the simplex representations of the classifier model per class, and a normalized simplex of classifier outputs for three high probability classes, according to embodiments of the present invention;

FIGS. 8a-d show the classification results for all the methods presented, according to embodiments of the present invention;

FIGS. 9a and 9b present the computational time comparison between methods of inference with and without sub-sampling, according to embodiments of the present invention; and

FIG. 10 is a listing of pseudo-code of a process for determining a point cloud {λₜ} that approximates a distribution over posterior class probabilities for time k (i.e. [symbol] (λₜ|z_{1:t})), according to an embodiment of the present invention.

### DETAILED DESCRIPTION OF THE PREFERRED EMBODIMENTS

Embodiments of the present invention provide methods for inferring a distribution over posterior class probabilities with a measure of uncertainty using a deep learning NN classifier. As opposed to prior methods, the approach disclosed herein facilitates quantification of uncertainty in posterior classification given all historical observations, and as such facilitates robust classification, object-level perception and safe autonomy. In particular, we provide a current posterior class probability vector that is a function of a previous posterior class probability vector, accounting for model uncertainty. We used a sub-sampling approximation to obtain a point cloud that approximates the function's distribution. Our approach was studied both in simulation and with real images fed into a deep learning classifier, providing classification posterior along with uncertainty estimates for each time instant

### Problem Formulation

Consider a robot observing a single object from multiple viewpoints, aiming to infer its class while quantifying uncertainty in the latter. Each class probability vector is γₖ [symbol] [γₖ¹ . . . γₖⁱ . . . γₖ^{M}], where M is the number of candidate classes. Each element γₖⁱ is the probability of object class c being i given image zₖ, i.e. γₖⁱ≡ [symbol] (c=i|zₖ), while γₖ resides in the (M−1) simplex such that

γₖⁱ≥0 ∥γₖ∥₁=1. (1)

Existing Bayesian sequential classification approaches do not consider model uncertainty, and thus maintain a posterior distribution λₖ for time k over c,

λₖ [symbol] (c|γ_{1:k}), (2)

given history γ_{1:k} obtained from images z_{1:k}. In other words, λₖ is inferred from a single sequence of γ_{1:k}, where each γₜ for t ∈ [1, k] corresponds to an input image zₜ. However, the posterior class probability λₖ by itself does not provide any information regarding how reliable the classification result is due to model uncertainty. For example, a classifier output γₖ may have a high score for a certain class, but if the input is far from the classifier training set the result is not reliable and may vary greatly with small changes in the scenario and classifier weights.

Embodiments of the present invention quantify model uncertainty, i.e. quantify how “far” an image input zₜ is from a training set D by modeling the distribution [symbol] (γₜ|zₜ, D). Given a training set D and classifier weights w, the output γₜ is a deterministic function of input zₜ for all t ∈ [1, k]:

γₜ=ƒ_{w}(zₜ), (3)

where the function ƒ_{w} is a classifier with weights w. However, w are stochastic given D, thus inducing a probability [symbol] (w|D) and making γₜ a random variable. Gal and Ghahramani showed that an input far from the training set will produce vastly different classifier outputs for small changes in weights. Unfortunately, [symbol] (w|D) is not given explicitly. To combat this issue, Gal and Ghahramani proposed to approximate [symbol] (w|D) via dropout, i.e. sampling w from another distribution closest to [symbol] (w|D) in a sense of KL divergence. Practically, an input image zₜ is run through an NN classifier with dropout multiple times to get many different γₜ's for corresponding w realizations, creating a point cloud of class probability vectors. Note that every distribution described herein is dependent on the training set D. This reference to D is omitted in the equations below.

Hereinbelow, a class-dependent likelihood [symbol] (γₖ) [symbol] [symbol] (γₖ|c=i), referred as a likelihood classifier model, is utilized. This likelihood classifier model is a likelihood vector denoted as [symbol] (γₖ) [symbol] [ [symbol] ₁(γₖ) . . . [symbol] _{M}(γₖ)]. (An uninformative prior [symbol] (c=i)=1/M is assumed.) The likelihood classifier model is based on a Dirichlet distributed classifier model with a different hyperparameter vector θᵢ ∈ [symbol] ^{M×1} per class i ∈ [1, M], such that [symbol] (γₖ|c=i) may be written as:

[symbol]

ᵢ(γₖ)=Dir(γₖ; θᵢ). (4)

The Dirichlet distribution is the conjugate prior of a categorical distribution, and therefore supports class probability vectors, particularly γₖ. Sampling from a Dirichlet distribution necessarily satisfies conditions (1), unlike other distributions such as Gaussian. The probability density function (PDF) of the above distribution is as follows:

$${𝕃}_{i} ( {γ}_{k} ) = C ( {θ}_{i} ) {\prod }_{j = 1}^{M} {( {γ}_{k}^{j} )}^{{θ}_{i}^{j} - 1} , \qquad ( 5 )$$

where C(θᵢ) is a normalizing constant dependent on θᵢ, and θᵢ^{j} is the j-th element of vector θᵢ.

[symbol]

(γₖ|c=i) [symbol] ᵢ(γₖ), [symbol] (·|c=i) [symbol] [symbol] ᵢ. (6)

The likelihood classifier model [symbol] ᵢ(γₖ) must be distinguished from the model uncertainty derived from [symbol] (γₖ|zₖ) for class i and time step k. The likelihood classifier model [symbol] ᵢ(γₖ) is the likelihood of a single γₖ given a class hypothesis i. The hyperparameters θᵢ^{j} of the model are inferred (i.e., computed) prior to the scenario for each class from the training set, and these parameters are taken as constant within the scenario. Methods for computing the hyperparameters are described in section 3 of J. Huang, “Maximum likelihood estimation of Dirichlet distribution parameters,” CMU Technique Report, 2005. By contrast, [symbol] (γₖ|zₖ) is the probability of γₖ given an image zₖ, and is computed during the scenario. Note that if the true object class is i and it is “close” to the training set, the probabilities [symbol] (γₖ|zₖ) and [symbol] ᵢ(γₖ) will be “close” to each other as well.

A key observation is that λₖ is a random variable, as it depends on γ_{1:k} (see Eq. (2)) while each γₜ, with t ∈ [1, k], is a random variable distributed according to [symbol] (γₜ|zₜ, D). Thus, rather than maintaining the posterior Eq. (2), our goal is to maintain a distribution over posterior class probabilities for time k, i.e.

[symbol]

(λₖ|z_{1:k}). (7)

This distribution permits the calculation of the posterior class distribution, [symbol] (c|z_{1:k}), via expectation

$$ℙ ( c = i \vert {z}_{1 : k} ) = {\int }_{{λ}_{k}^{i}} ℙ ( c = i \vert {λ}_{k}^{i} , {z}_{1 : k} ) ℙ ( {λ}_{k}^{i} \vert {z}_{1 : k} ) d {λ}_{k}^{i} = {\int }_{{λ}_{k}^{i}} ℙ ( c = i \vert {λ}_{k}^{i} ) ℙ ( {λ}_{k}^{i} \vert {z}_{1 : k} ) d {λ}_{k}^{i} = 𝔼 [ {λ}_{k}^{i} ] , \qquad ( 8 )$$

based on the identity [symbol] (c=i|λₖⁱ)=λₖⁱ.

Moreover, as will be seen, Eq. (7) allows to quantify the posterior uncertainty, thereby providing a measure of confidence in the classification result given all data thus far.

Here, it is useful to summarize our assumptions:
1. A single object is observed multiple times.
2. [symbol] (γₜ|zₜ, D) is approximated by a point cloud {γₜ} for each image zₜ.
3. An uninformative prior for [symbol] (c=i).
4. A Dirichlet distributed classifier model with designated parameters for each class c ∈ [1, . . . , M]. These parameters are constant and given (e.g. learned).

### Approach

We aim to find a distribution over the posterior class probability vector λₖ for time k, i.e. [symbol] (λₖ|z_{1:k}). First, λₖ is expressed given some specific sequence γ_{1:k}. Using Bayes' law:

λₖⁱ= [symbol] (c=i|γ_{1:k}) ∝ [symbol] (c=i|γ_{1:k-1}) [symbol] (γₖ|c=i, γ_{1:k-1}). (9)

We assume, for simplicity, that NN classifier outputs are statistically independent. (Hereinbelow, viewpoint-dependent classifier models are not applied and models are assumed to be γ_{1:k} statistically independent from each other.) We can re-write Eq. (9) as

λₖⁱ ∝ [symbol] (c=i|γ_{1:k-1}) [symbol] (γₖ|c=i). (10)

Per the definition for λₖ₋₁ (Eq. (2)) and [symbol] (γₖ|c=i) (Eq. (6)), λₖⁱ assumes the following recursive form:

λₖⁱ ∝ λₖ₋₁ⁱ [symbol] ᵢ(γₖ). (11)

Given that γₜ (for each time step t ∈ [1, k]) is a random variable, λₖ₋₁ⁱ and λₖⁱ are also random variables. Thus, our problem is to infer [symbol] (λₖ|z_{1:k}), where, according to Eq. (11), for each realization of the sequence γ_{1:k}, λₖ is a function of λₖ₋₁ and γₖ.

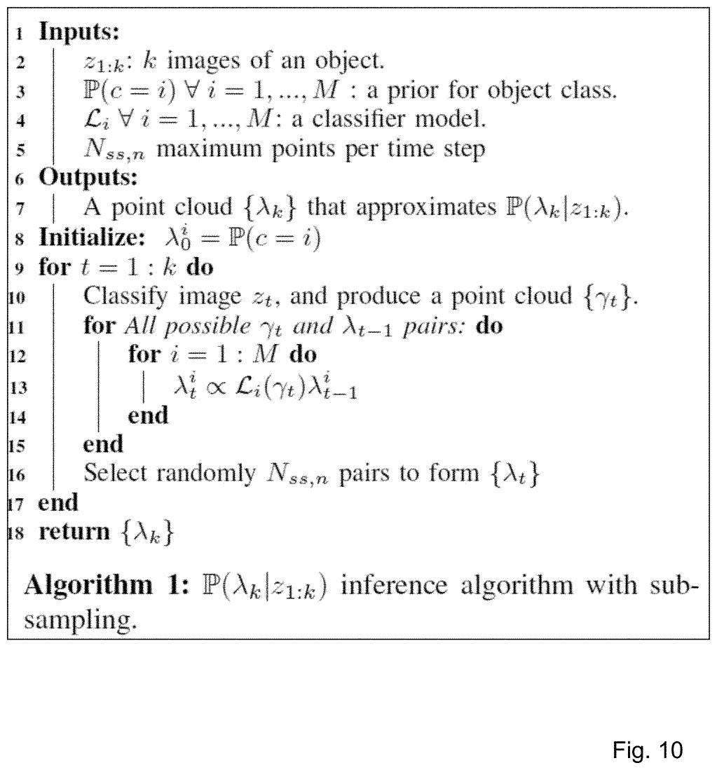

The approach is shown as Algorithm 1 of FIG. 10. At each time step t, a new image zₜ is classified using multiple forward passes through a CNN with dropout, yielding a point cloud {γₜ}. Each forward pass gives a probability vector γₜ ∈ {γₜ}, which is used to compute a Dirichlet distribution of the class likelihood [symbol] (γₜ). In addition, {λₜ₋₁} is a point cloud (i.e., set of elements) from the previous step. All possible pairs of λₜ₋₁ⁱ and [symbol] ᵢ(γₜ) are multiplied, as in Eq. (11). Finally N_{ss,n} pairs are chosen for the next step, in a sub-sampling algorithm that will be detailed hereinbelow. This results in a point cloud {λₜ} that approximates [symbol] (λₜ|z_{1:t}).

The algorithm must be initialized for the first image. Recalling Eq. (2), λ₁ⁱ (first image) is defined for class i and time k=1 as:

λ₁ⁱ [symbol] [symbol] (c=i|γ₁). (12)

### Using Bayes law:

$$ℙ ( c = i \vert {γ}_{1} ) = \frac{ℙ ( {γ}_{1} \vert c = i ) ℙ ( c = i )}{ℙ ( {γ}_{1} )} \qquad ( 13 )$$

where [symbol] (c=i) is a prior probability of class i, [symbol] (γ₁) serves as a normalizing term, and [symbol] (γ₁|c=i) is the classifier model for class i. Per definition Eq. (6), Eq. (13) can be written as:

λ₁ⁱ ∝ [symbol] (c=i) [symbol] ᵢ(γ₁), (14)

thus λ₁ⁱ is a function of prior [symbol] (c=i) and γ₁, and in the subsequent steps the update rule of Eq. (11) can be used to infer [symbol] (λₖ|z_{1:k}).

It should be noted that there is a numerical issue where λₖⁱ for sufficiently large k can practically become 0 or 1, preventing any possible change for future time steps. In embodiments of the present invention, this is overcome this by calculating log λₖⁱ instead of λₖⁱ.

In the next section the properties of [symbol] (λₖ|z_{1:k})) are reviewed, as well as the corresponding posterior uncertainty versus time. Two inference approaches that approximate this PDF are presented.

Inference Over the Posterior [symbol] (λₖ|z_{1:k})

In this section the distribution [symbol] (λₖ|z_{1:k}) is analyzed to provide an inference method to track this distribution over time. As discussed above, all γₜ are random variables; hence, according to Eq. (11), [symbol] (λₖ|z_{1:k}) accumulates all model uncertainty data from all [symbol] (γₜ|zₜ) up until time step k, with t ∈ [1, k].

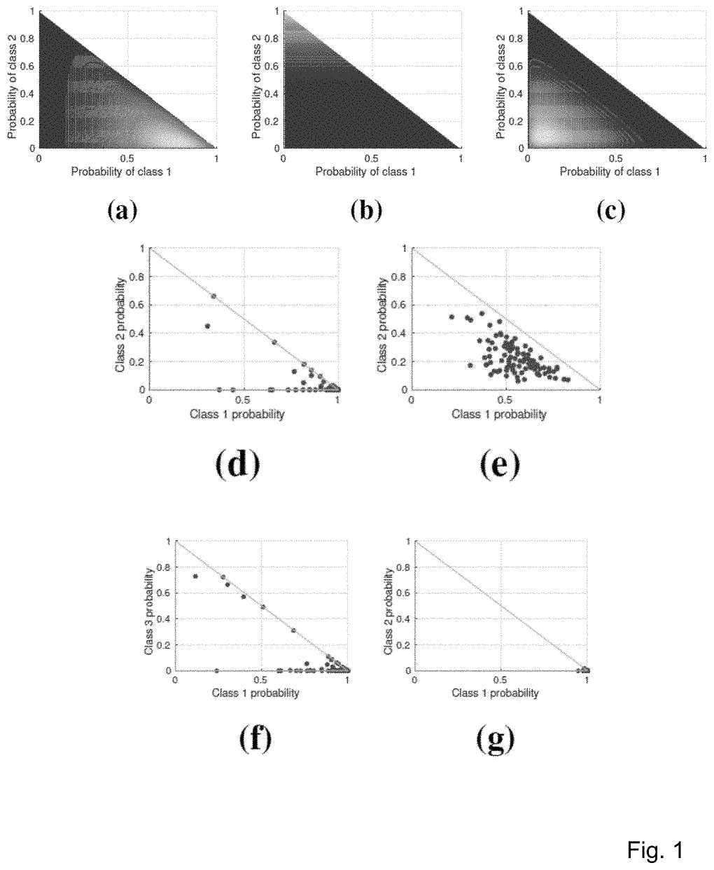

FIGS. 1a-g illustrate examples for inference of [symbol] (λₖ|z_{1:k}) from [symbol] (γₖ|zₖ) and [symbol] (λₖ₋₁|z_{1:k}) using a known classifier model, considering three possible classes. FIGS. 1a-c present example distributions for the classifier model. FIG. 1d presents a point cloud that describes the distribution of λₖ₋₁. FIG. 1e presents [symbol] (γₖ|zₖ) represented by a point cloud of γₖ instances. Each γₖ is projected via [symbol] (γₖ) to a different cloud in the simplex, as presented in FIG. 1f. Finally, based on Eq. (11), the multiplication of points from FIGS. 1d and 1f creates a {λₖ} point cloud, shown in FIG. 1g. In the presented scenario, the spread of the {λₖ} point cloud (FIG. 1g) was smaller than the spread of {λₖ₋₁} (FIG. 1d), because both point clouds {λₖ₋₁} and { [symbol] (γₖ)} are near the same simplex edge. In general, classifier models with large parameters (see Eq. 5) create { [symbol] (γₜ)} point clouds that are closer to the simplex edge. In turn, the {λₖ} point cloud (updated via Eq. (11)) will converge faster to a single simplex edge.

The graphs of FIG. 1 thus illustrate the inference process of [symbol] (λₖ|z_{1:k}). FIGS. 1a-c show the [symbol] ᵢ classifier model for classes 1,2 and 3, respectively, with higher probability zones presented in yellow. FIG. 1d shows the distribution of λₖ₋₁ from the previous step. Note that for k=1, λ₀ is given by the prior [symbol] (c). FIG. 1e shows a point cloud {γₖ} approximating [symbol] (γₖ|zₖ) via multiple forward passes of the (CNN) classifier with dropout, given a new measurement zₖ (an image) at current time step k. FIG. 1f shows the corresponding likelihood [symbol] (γₖ) for each γₖ ∈ {γₖ} from FIG. 1e. Finally, multiplying λₖ₋₁ and [symbol] (γₖ) (Eq. (11)) results in the point cloud shown in FIG. 1f representing a distribution over λₖ. λₖ's spread is smaller in this case than λₖ₋₁'s, as both [symbol] (γₖ) and [symbol] (λₖ₋₁|zₖ₋₁) are close to the same simplex corner.

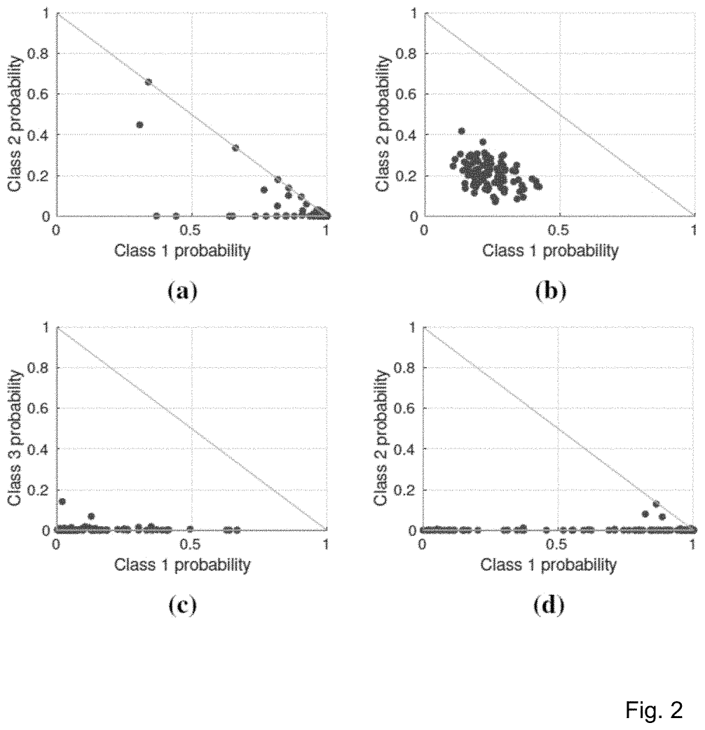

As shown in the graphs, the spread of {λₖ} is indicative of accumulated model uncertainty, and is dependent on the expectation and spread of both {λₖ₋₁} and {γₖ}. For specific realizations of λₖ₋₁ and γₖ, as seen in Eq. (11), λₖⁱ is a multiplication of λₖ₋₁ⁱ and [symbol] ᵢ(γₖ). Therefore, when [symbol] (γₖ) is within the simplex center, i.e. [symbol] ᵢ(γₖ)= [symbol] ⱼ(γₖ) for all i, j=1, . . . , M, the resulting λₖ will be equal to λₖ₋₁. On the other hand, when [symbol] (γₖ) is at one of the simplex' edges, its effect on λₖ will be the greatest. Expanding to the probability [symbol] (λₖ|z_{1:k}), there are several cases to consider. If [symbol] (λₖ₋₁|z_{1:k-1}) and { [symbol] (γₖ)} “agree” with each other, i.e. the highest probability class is the same, and both are far enough from the simplex center, the resulting [symbol] (λₖ|z_{1:k}) will have a smaller spread compared to [symbol] (λₖ₋₁|z_{1:k-1}) and its expectation will have the dominant class with a high probability. On the other hand, if [symbol] (λₖ₋₁|z_{1:k-1}) and { [symbol] (γₖ)} “disagree” with each other, i.e. they are close to the same simplex corner, the spread of [symbol] (λₖ|z_{1:k}) will become larger; an example for this case is illustrated in FIG. 2. In practice such a scenario can occur when an object of a certain class is observed from a viewpoint where it appears like a different class. If both [symbol] (λₖ₋₁|z_{1:k-1}) and { [symbol] (γₖ)} are near the simplex center, the spread of [symbol] (λₖ|z_{1:k}) will increase as well. Finally, if only one of [symbol] (λₖ₋₁|z_{1:k-1}) and { [symbol] (γₖ)} is near the simplex center, [symbol] (λₖ|z_{1:k}) will be similar to the one that is farther from the simplex center.

As described above, the graphs of FIGS. 2a-d illustrate a case where the posterior uncertainty grows with an additional image. The classifier model is the same as in FIG. 1, as well as the inference steps. FIG. 2a represents [symbol] (λₖ₋₁|zₖ₋₁). In FIG. 2b the point cloud {γₖ} is closer to class 3, compared to {λₖ₋₁} cloud from FIG. 2a, which is closer to class 1. The classifier model translates γₖ into [symbol] (γₖ) in FIG. 2c, projecting the point cloud around class 3, and thus after the multiplication shown in FIG. 2d, the distribution is more spread out compared to FIG. 2a.

From [symbol] (λₖ|z_{1:k}) the expectation [symbol] (λₖ) (computed as in Eq. (8)) and covariance matrix Cov(λₖ) of λₖ may be calculated. [symbol] (λₖ) takes into account model uncertainty from each image, unlike existing approaches (e.g. Omidshafiei, et al., “Hierarchical Bayesian noise inference for robust real-time probabilistic object classification,” preprint arXiv:1605.01042, 2016). Consequently, we achieve a posterior classification that is more resistant to possible aliasing. The covariance matrix Cov(λₖ) represents the spread of λₖ, and in turn accumulates the model uncertainty from all images z_{1:k}. In general, lower Cov(λₖ) values represent smaller λₖ spread, and thus higher confidence with the classification results. Practically, this can be used in a decision making context, where higher confidence answers are preferred. For example, values of Var(λₖⁱ) for all classes i=1, . . . , M may be compared, as a means of describing the uncertainty per class.

Furthermore, there is a correlation between the expectation [symbol] (λₖ) and Cov(λₖ). The largest covariance values will occur when [symbol] (λₖ) is at the simplex' center. In particular, it is not difficult to show that the highest possible value for Var(λₖⁱ) for any i is 0.25; it can occur when λₖⁱ=0.5. In general, if [symbol] (λₖ) is close to the simplex' boundaries, the uncertainty is lower. Therefore, to reduce uncertainty, [symbol] (λₖ) should be concentrated in a single high probability class.

The expression [symbol] (λₖ|z_{1:k}), where the expression for λₖ is described in Eq. (11), has no known analytical solution. The next most accurate method available is multiplying all possible permutations of point clouds {γₜ}, for all images at times t ∈ [1, k]. This method is computationally intractable as the number of λₖ points grows exponentially. The next section provides a simple sub-sampling method to approximate this distribution and keep computational tractability.

### Sub-Sampling Inference

As mentioned above, for each measurement, a “cloud” (i.e., a set) of Nₖ probability vectors {(γₖ)ⁿ}ₙ₌₁^{N}^{ₖ} is generated. Each probability vector is projected via the classifier model to a different point with the simplex, which provides a new point cloud { [symbol] (γₖ)ⁿ}ₙ₌₁^{N}^{ₖ}. We assume that [symbol] (λₖ₋₁|z_{1:k-1}) is described by a cloud of Nₖ₋₁ points. Given the data for γₖ and λₖ₋₁, the most accurate approximation to [symbol] (λₖ|z_{1:k}) is given by multiplying all possible pairs of λₖ₋₁ and [symbol] (γₖ). Thus, [symbol] (λₖ|z_{1:k}) is described with a cloud of Nₖ₋₁×Nₖ points. For subsequent steps the cloud size grows exponentially, making it computationally intractable. We address this problem by randomly sampling from the point cloud for λₖ a subset of N_{ss,n} points and use them for the next time step. In practice, N_{ss,n} may be kept constant across all time steps, as indicated in line 16 in Algorithm 1.

### Experiments

In this section we present results of our method using real images fed into an AlexNet CNN classifier (as described by Krizhevsky, et al., “Imagenet classification with deep convolutional neural networks,” Advances in neural information processing systems, pages 1097-1105, 2012). We used a PyTorch implementation of AlexNet for classification, and Matlab for sequential data fusion. The system ran on an Intel i7-7700HQ CPU running at 2.8 GHz, and 16 GB of RAM. We compare four different approaches:
1. Method- [symbol] (c|z_{1:k})-w/o-model: Naive Bayes that infers the posterior of [symbol] (c|z_{1:k}) where the classifier model is not taken into account (SSBF, as described in Omid-shafiei, cited above).
2. Method- [symbol] (c|z_{1:k})-w-mode 1: A Bayesian approach that infers the posterior of [symbol] (c|z_{1:k}) and uses a classifier model; essentially using Eq. (11) with a known classifier model.
3. Method- [symbol] (λₖ|z_{1:k})-AP: Inference of [symbol] (λₖ|z_{1:k}) multiplying all possible combinations of λₖ₋₁ and [symbol] (γₖ). Note that the number of combinations grows exponentially with k, thus the results are presented up until k=5.
4. Method- [symbol] (λₖ|z_{1:k})-SS: Inference of [symbol] (λₖ|z_{1:k}) using the sub-sampling method.
   Embodiments of the present invention are represented by approaches 3 and 4.

### Simulated Experiment

A simulated experiment was conducted to demonstrate the performance of embodiments of the present invention. The simulation emulated a scenario of a robot traveling in a predetermined trajectory and observing an object from multiple viewpoints. This object's class was one of three possible candidates. We infer the posterior over λ and display the results as expectation [symbol] (λₖⁱ) and standard deviation per class i:

σᵢ [symbol] \sqrt{Var(λₖⁱ)}. (15)

The simulation demonstrated the effect of using a classifier model in the inference for highly ambiguous measurements. In addition, the uncertainty behavior for the scenario is indicated. A categorical uninformative prior of [symbol] (c=i)=1/M was used for all i=1, . . . , M.

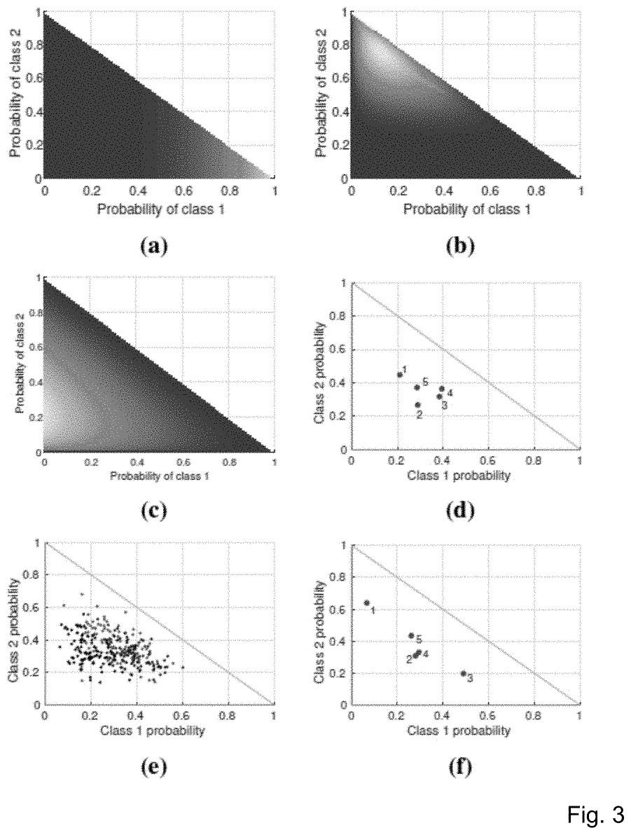

Each of the three classes has its own (known) classifier model Eq. (16), as shown in FIGS. 3a-c. The classifier model is assumed to be Dirichlet distributed with the following hyperparameters θᵢ for all i ∈ [1, 3]:

θ₁=[6 1 1]

θ₂=[2 7 2]

θ₃=[1 1.5 2]. (16)

In this experiment the true class was 3. The hyperparameters were selected to simulate a case where the γ measurements were spread out (corresponding to ambiguous appearance of the class), thus leading to incorrect classification without a classifier model. The classifier model for this class [symbol] ₃ predicts highly variable γ's using the training data (FIG. 3c). The {γₜ} point clouds for each t ∈ [1, k] are different from each other (FIG. 3e), representing an object photographed by a robot from multiple viewpoints.

We simulated a series of 5 images. Each image at time step t has its own different [symbol] (γₜ|zₜ). For the approaches that infer [symbol] (c|z_{1:k}), we sampled a single γₜ per image zₜ for all t ∈ [1, k] (FIG. 3f, also presents the γₜ order). This sample simulated the usual single classifier forward pass that was used. Ten γₜ's from each [symbol] (γₜ|zₜ) were sampled, except for the first step t=1 where 100 γ₁'s were sampled. For Method- [symbol] (λₖ|z_{1:k})-SS each {λₜ} point cloud was capped at 100 points. The expectation of these generated measurements are presented in FIG. 3d, along with the cloud order. In FIG. 3e {γₜ} point clouds for three different t's are presented in distinct colors. The input for methods 1 and 2 is shown in FIG. 3f, and some of the input for methods 3 and 4 is shown in FIG. 3e.

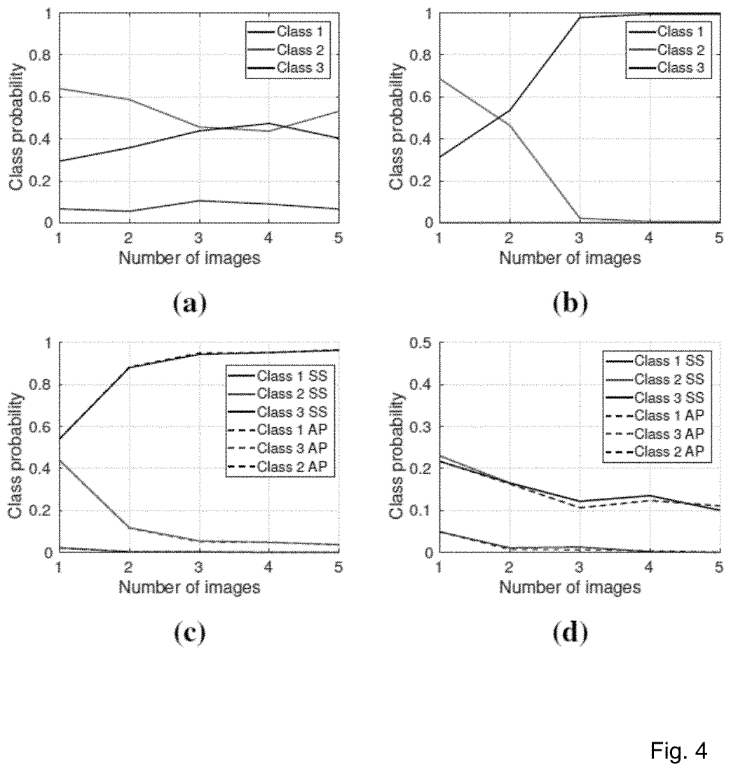

FIGS. 4a-d present results obtained with our methods, in terms of expectation [symbol] (λₖⁱ) and \sqrt{Var(λₖⁱ)} for each class i, as a function of classifier measurements. FIGS. 4a-c show posterior class probabilities: FIG. 4a shows Method- [symbol] (c|z_{1:k})-w/o-model; FIG. 4b shows Method- [symbol] (c|z_{1:k})-w-model; FIG. 4c shows [symbol] (c|z_{1:k}) calculated via expectation (8) for Method- [symbol] (λₖ|z_{1:k})-SS and Method- [symbol] (λₖ|z_{1:k})-AP; FIG. 4d shows the posterior standard deviation Eq. (15) for both of our methods.

In FIGS. 4a and 4b we used a single sampled γₜ for zₜ (see FIG. 3f), while in FIGS. 4c and 4d we create a {γₜ} point cloud for zₜ (see FIG. 3e). In FIGS. 4a and 4b results are shown for Method- [symbol] (c|z_{1:k})-w/o-model and Method- [symbol] (c|z_{1:k})-w-model respectively. Without classifier model the results generally favor class 2 incorrectly, as the measurements tend to give that class the higher chances. With classifier models the results favor class 3, the correct class. Because the classifier model for class 3 is more spread out than for the other classes, γ's in the simplex middle (as in FIG. 3e) have higher [symbol] ₃(γ) values than [symbol] ₁(γ) and [symbol] ₂(γ). While method Method- [symbol] (c|z_{1:k})-w-model gives eventually correct classification results, it does not account for model uncertainty, i.e. uses a single classifier output γ obtained with a forward run through the classifier without dropout. In this simulation we sample a single γ from each point cloud to simulate this forward run.

FIGS. 4c and 4d present the results for the two methods Method- [symbol] (λₖ|z_{1:k})-SS and Method- [symbol] (λₖ|z_{1:k})-AP, expectation and standard deviation respectively. Throughout the scenario class 3 has the highest probability correctly, and the deviation drops as more measurements are introduced. Compared to FIG. 4b where class 3 has high probability only at time step t=3, in FIG. 4c class 3 is the most probable from time step t=1. Both Method- [symbol] (λₖ|z_{1:k})-SS and Method- [symbol] (λₖ|z_{1:k})-AP behave similarly. Note that class 1 has much smaller deviation than the other two because its probability is close to 0 through the entire scenario.

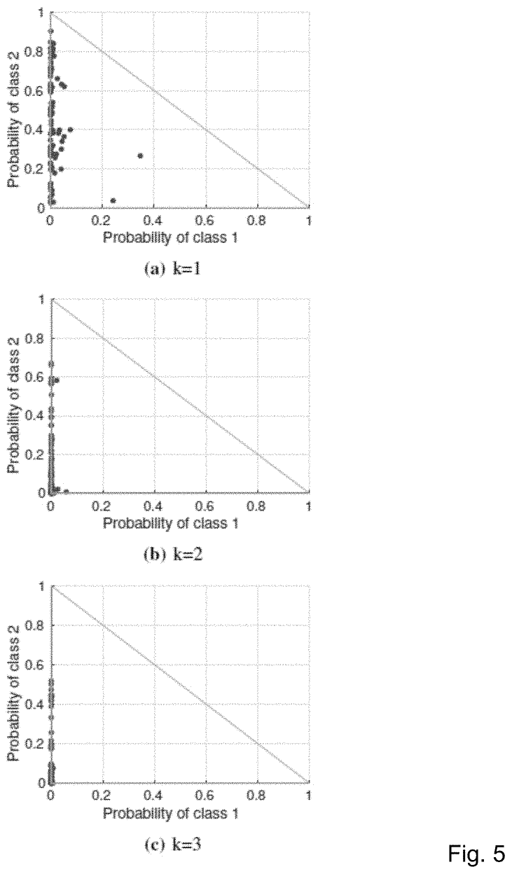

FIGS. 5a-c present the development of {λₖ} point clouds for Method- [symbol] (λₖ|z_{1:k})-SS at different time steps. These figures show the gradual decrease in {λₖ}'s spread, coinciding with the corresponding standard deviation in FIG. 4d.

Experiment with Real Images

Our method was tested using a series of images of an object (space heater) with conflicting classifier outputs when observed from different viewpoints. This corresponds to a scenario where a robot in a predetermined path observes an object that is obscured by occlusions and different lighting conditions. The experiment presents our method's robustness to these difficulties in classification, and addressing them is important for real-life robotic applications.

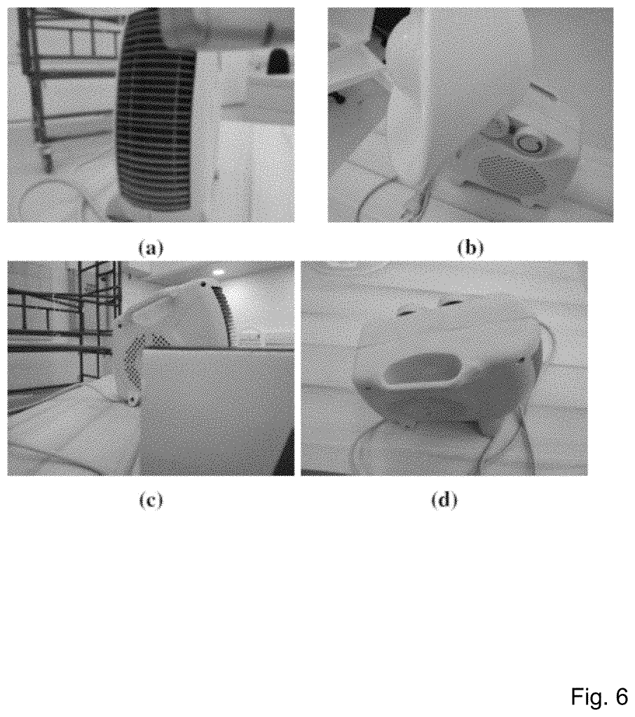

The database photographed was a series of 10 images of a space heater with artificially induced blur and occlusions. Each of the images was run through an AlexNet convolutional neural network (NN classifier) with 1000 possible classes. As with the simulation described above, we used an uninformative classifier prior on [symbol] (c) with [symbol] (c=i)=1/M for all i=1, . . . , M classes. Our method was used to fuse the classification data into a posterior distribution of the class probability and infer deviation for each class. As with the simulation, we generated results with and without a classifier model. FIGS. 6a-d present four of the dataset images, exhibiting occlusions, blur and different colored filters in a monotone environment.

The methods described in the previous sub-sections were implemented as follows. For Method- [symbol] (c|z_{1:k})-w/o-model and Method- [symbol] (c|z_{1:k})-w-model, images were run through a neural network (NN) classifier without dropout and used a single output γ for each image. For Method- [symbol] (λₖ|z_{1:k})-SS, each image was run 10 times through the NN classifier with dropout, producing a point cloud {γ} per image. The cap for the number of λₖ points with the method Method- [symbol] (λₖ|z_{1:k})-SS was 100. For Method- [symbol] (λₖ|z_{1:k})-AP, results are presented only for the first five images as the calculations became infeasible due to the exponential complexity.

As the AlexNet NN classifier has 1000 possible classes (one of them is “Space Heater”), it is difficult to clearly present results for all of them. Because the goal was to compare the most likely classes, we selected 3 likely classes by averaging all γ outputs of the NN classifier and selecting the three with highest probability. The probabilities for those classes were then normalized, and utilized in the scenario. All other classes outside those three were ignored. For each class, we applied a likelihood classifier model; assuming the likelihood classifier model is Dirichlet distributed, we classified multiple images unrelated to the scenario for each class with the same AlexNet NN classifier but without dropout. The classifier produced multiple γ's, one per image, and via a Maximum Likelihood Estimator we inferred the Dirichlet hyperparameters for each class i ∈ [1, 3]. The classifier model [symbol] (λₖ|c=i)=Dir(γₖ; θᵢ) was used with the following hyperparameters θᵢ:

θ₁=[5.103 1.699 1.239]

θ₂=[0.143 208.7 5.31]

θ₃=[0.993 14.31 25.21] (17)

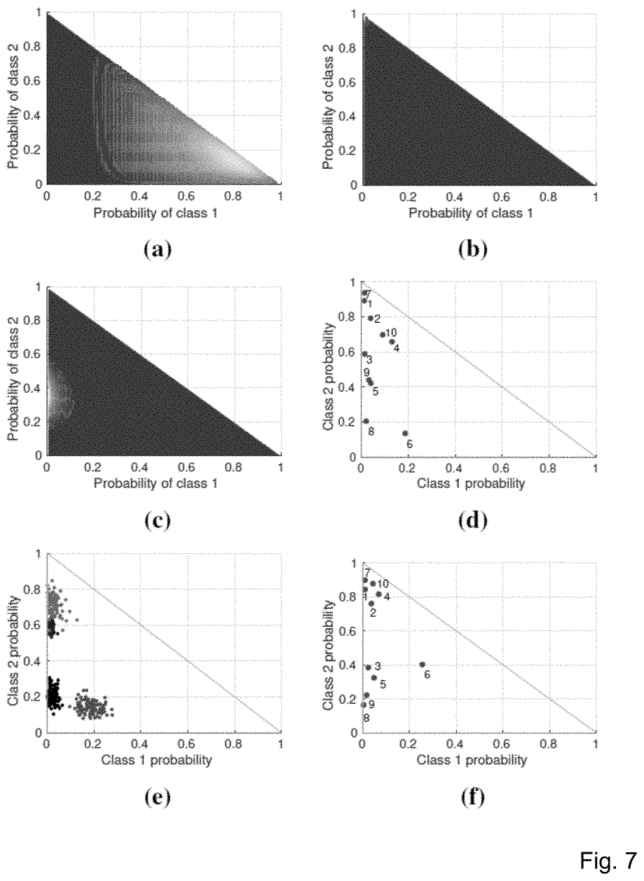

In this experiment, class 1 is the correct class (i.e. “Space Heater”). FIGS. 7a-f present the simplex representations of the classifier model per class, and a normalized simplex of classifier outputs for three high probability classes, similarly to the graphs in FIG. 3. The classifier model for class 1 is much more spread than the other two (FIG. 7a), therefore the likelihood of measurements within a larger area will be higher for this class. Interestingly, the classifier model for class 3 predicts [symbol] (γₖ|c=3) will be between classes 2 and 3 (FIG. 7c). FIG. 7e presents 4 of the 10 {γₜ} point clouds used in the scenario. FIG. 7d presents the expectation of each {γₜ} point cloud for t ∈ [1, 10]. FIG. 7f presents classifier outputs without dropout, i.e. a single γₜ per image. Both FIGS. 7d and 7f have indices that represent the images order.

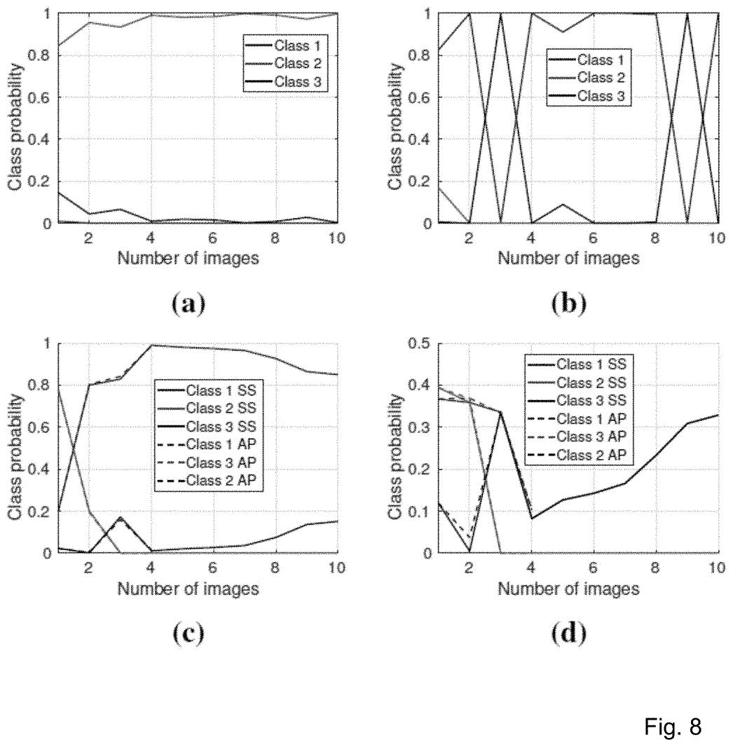

FIGS. 8a-d show the classification results for all the methods presented. FIGS. 8a and 8b show results for Method- [symbol] (c|z_{1:k})-w/o-model and Method- [symbol] (c|z_{1:k})-w-model respectively. The former methods that do not apply a classifier model incorrectly indicate class 2 as the most likely, because the classifier outputs often show class 2 as the most likely (see FIG. 7f). With a classifier model, the results show either class 1 or 3 as being most probable. This can be explained by the likelihood vector [symbol] from Eq. (17) that projects the γ's from different images approximately to different simplex edges (e.g. γ₂ and γ₄ for class 1, and γ₃ and γ₅ for class 3).

FIGS. 8c and 8d present results (i.e., the posterior class probabilities) for the two methods Method- [symbol] (λₖ|z_{1:k})-SS and Method- [symbol] (λₖ|z_{1:k})-AP, expectation and standard deviation respectively. FIG. 8c presents class 1 as most likely correctly in both methods from k=2 onwards, and the results are smoother than in FIG. 8b because our method takes into account multiple realizations of γ₁ to γ₁₀. This is due to using a point cloud of γ's for each image. In addition, the standard deviation of λₖ, representing the posterior uncertainty, can be analyzed as in FIG. 8d. Note that starting from the 4th image, the uncertainty increases, as later measurement likelihoods do not agree with λₖ₋₁ about the most likely class at those time steps, similar to the example presented in FIG. 2. Importantly, the results for method- [symbol] (λₖ|z_{1:k})-SS are similar to those for Method- [symbol] (λₖ|z_{1:k})-AP, while offering significantly shorter computational times.

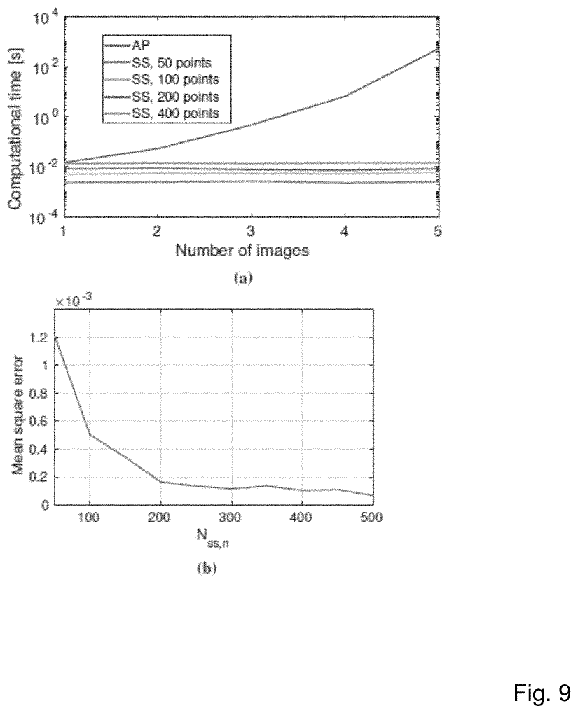

FIGS. 9a and 9b present the computational time comparison between the two methods for the scenario presented in this section, including different numbers of samples N_{ss,n} per time step. FIG. 9a shows a computational time comparison between Method- [symbol] (λₖ|z_{1:k})-AP and Method- [symbol] (λₖ|z_{1:k})-SS per time step. The figure presents computational times for N_{ss,n} ∈ {50, 100, 200, 400} points per time step for Method- [symbol] (λₖ|z_{1:k})-SS. FIG. 9b shows the statistical mean square error of Method- [symbol] (λₖ|z_{1:k})-SS as a function of N_{ss,n} ∈ [50, 500] relative to Method- [symbol] (λₖ|z_{1:k})-AP. Importantly, the results for Method- [symbol] (λₖ|z_{1:k})-SS are similar to Method- [symbol] (λₖ|z_{1:k})-AP while offering significantly shorter computational times. Note that the computational time per step is constant as well for Method- [symbol] (λₖ|z_{1:k})-SS. FIG. 9b presents mean square error (MSE) of Method- [symbol] (λₖ|z_{1:k})-SS compared to the method Method- [symbol] (λₖ|z_{1:k})-AP, as a function of N_{ss,n}. As expected, larger N_{ss,n} values produce lower MSE.

Processing elements of the system described herein may be implemented in digital electronic circuitry, or in computer hardware, firmware, software, or in combinations thereof. Such elements can be implemented as a computer program product, tangibly embodied in an information carrier, such as a non-transient, machine-readable storage device, for execution by, or to control the operation of, data processing apparatus, such as a programmable processor, computer, or deployed to be executed on multiple computers at one site or one or more across multiple sites. Memory storage for software and data may include multiple one or more memory units, including one or more types of storage media. Examples of storage media include, but are not limited to, magnetic media, optical media, and integrated circuits such as read-only memory devices (ROM) and random access memory (RAM). Network interface modules may control the sending and receiving of data packets over networks. Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove.

1. A method of classifying an object appearing in k multiple sequential images z_{1:k} of a scene, comprising:
A) determining, from a training set of training images of objects, a neural network (NN) classifier having M object classes for classifying objects in images;
B) determining a likelihood classifier model [symbol] ᵢ(γₖ) for each of the M object classes, and a likelihood vector [symbol] (γₖ) [symbol] [ [symbol] ₁(γₖ) . . . [symbol] _{M}(γₖ)], wherein each [symbol] ᵢ(γₖ) is a probability density function (PDF) of a class probability vector γₜ defined as γₜ [symbol] [γₜ¹ . . . γₜⁱ . . . γₜ^{M}], wherein each element γₜⁱ is the probability of a class of an object being i, given an image zₜ;
C) for each image zₜ of the k images, running the image multiple respective times through the NN classifier, applying dropout each time to modify weights of the NN classifier, to generate a point cloud {γₜ} of multiple γₜ values, and for each of the multiple γₜ values, calculating a vector λₜ of posterior distributions λₜⁱ for each class, i=1:M, where λₜ [symbol] [λₜ¹ . . . λₜⁱ . . . λₜ^{M}], wherein each λₜⁱ is the probability of an object being of class i, given the history of images z_{i:t}, wherein calculating each element λₜⁱ of the vector λₜ comprises multiplying the values of all [symbol] ᵢ(γₜ), for all i=1:M, by each element of a posterior distribution of a prior image λₜ₋₁ⁱ, such that λₜⁱ is proportional to [symbol] ᵢ(γₜ)λₜ₋₁ⁱ, wherein the posterior distribution of λₜ₋₁ⁱ has Nₜ₋₁ points and the distribution of [symbol] ᵢ(γₜ) has Nₜ points, such that the distribution of {λₜ} has Nₖ₋₁×Nₖ points;
D) randomly selecting a subset of N_{ss,n} points of {kₜ} to form a new subset {λₜ}, wherein N_{ss,n} is a preset maximum number of elements of {λₜ} for each image; and
E) repeating steps C and D with the new subset {λₜ}, for each of the t=1:k images, to determine a cloud of posterior probability vectors {λₖ}.

2. The method of claim 1, further comprising calculating an expectation E(λₜ₋₁ⁱ) for each of the distributions of λₜⁱ of the cloud of posterior probability vectors {λₖ}.

3. The method of claim 2, further comprising calculating a variance \sqrt{Var(λₖⁱ)}, corresponding to a classifier model uncertainty, for each of the distributions of λₖⁱ of the cloud of posterior probability vectors {λₖ}.

4. The method of claim 1, wherein each [symbol] ᵢ(γₜ) is a Dirichlet distributed classifier model.

5. The method of claim 1, wherein the cloud of posterior probability vectors {λₖ} is an approximation of a distribution over posterior class probabilities given all the multiple sequential images, [symbol] (λₖ|z_{1:k}).

6. The method of claim 5, wherein the distribution over posterior class probabilities given all the k multiple sequential images, [symbol] (λₖ|z_{1:k}) accumulates model uncertainty data from all [symbol] (γₜ|zₜ) for all respective time steps t corresponding to a first through a last of the k images.

7. The method of claim 5, wherein a highest probability class being the same for both [symbol] (λₖ₋₁|z_{1:k-1}) and { [symbol] ᵢ(γₖ)} determines that [symbol] (λₖ|z_{1:k}) has a smaller spread compared to [symbol] (λₖ₋₁|z_{1:k-1}).

8. The method of claim 5, wherein a highest probability class being the same for both [symbol] (λₖ₋₁|z_{1:k-1}) and { [symbol] ᵢ(γₖ)} determines a high probability of an expectation of [symbol] (λₖ|z_{1:k}) being the highest probability class.

9. The method of claim 5, wherein if only one of [symbol] (λₖ₋₁|z_{1:k-1}) and { [symbol] ᵢ(γₖ)} are near a simplex center, [symbol] (λₖ|z_{1:k}) will be similar to the one farther from the simplex center.

10. The method of claim 1, wherein each [symbol] ᵢ(γₖ) is trained using images of instances of object of class c=i and a corresponding classifier output γₜⁱ.
